(19) United States
(12) Patent Application Publication
(10) Pub. No.: US 2013/0231786 A1
(43) Pub. Date: Sep. 5, 2013

(54) ENGINEERING DEVICE AND POINT INFORMATION GENERATING METHOD

(71) Applicant: Takashi Noguchi, Tokyo (JP)

(72) Inventor: Takashi Noguchi, Tokyo (JP)

(73) Assignee: AZBIL CORPORATION, Tokyo (JP)

(21) Appl. No.: 13/884,194

(22) PCT Filed: Oct. 24, 2011
(86) PCT No.: PCT/JP2011/074403

§ 371 Date: May 8, 2013

(30) Foreign Application Priority Data
Nov. 8, 2010 (JP) 2010-249526

(51) Int. Cl. G05D 23/19

(52) U.S. Cl. CPC G05D 23/19
USPC 700/277

(57) ABSTRACT

An engineering device includes a template producing unit that produces a template that defines monitoring point information and control point information as information for an object that is an equipment subject to monitoring/control, a system defining unit that defines system information for each equipment of a facility that is subject to monitoring/control, a physical entity deploying unit that produces monitoring point information and control point information for each individual equipment by deploying the template, for each individual equipment within the facility, following the system information, and a modification processing unit that regenerates the monitoring point information and control point information for each individual equipment, by deploying, to each individual equipment within the facility, a post-modification template, following the system information, when a modification has been made to the template.

### CROSS-REFERENCE TO RELATED APPLICATIONS

This is a U.S. national phase application under 35 U.S.C. §371 of International Patent Application No. PCT/JP2011/074403, filed on Oct. 24, 2011, and claims benefit of priority to Japanese Patent Application No. 2010-249526, filed Nov. 8, 2010. The International Application was published on May 18, 2012 as International Publication No. WO 2012/063627 under PCT Article 21(2). The entire contents of these applications are hereby incorporated by reference.

### FIELD OF TECHNOLOGY

The present invention relates to an engineering device, and a point information generating method, for generating monitoring point information and control point information used in a monitoring device for monitoring/controlling facilities such as an office building.

### BACKGROUND

Conventionally, in monitoring devices for monitoring and controlling facilities such as buildings and plants 24-hours-a-day, details such as identifiers for devices, device definition information, monitoring points, and the like, that are subject to monitoring, are defined in advance for each location wherein equipment is installed. The monitoring point and control point information is defined in advance each time engineering operations are performed. In an office building, or the like, identical spatial specifications, known as a “reference floor” are repeated multiple times, depending on the number of floors. Conventionally, as an engineering tool, operations have been performed wherein, after a monitoring point or control point that is required by one unit of equipment has been defined, it has been deployed to a plurality of equipment units through copying and pasting.

In the monitoring device disclosed in Japanese Unexamined Patent Application Publication 2005-18119, device templates, comprising information such as a device type, indicating the type of equipment that is to be monitored, and a point name, a point number, and a point type are prepared in advance for the various types of equipment that are to be monitored, and these device templates are used to achieve increased efficiency in engineering operations by producing a control point and monitoring point definition information.

The reality is that in the configurations of monitoring points/control points there are frequently additions and changes from the early stages of design through completion. In conventional engineering tools, because the operation is performed by defining the monitoring point/control point required for one unit of equipment and then copying and pasting to deploy to a plurality of equipment, when there is a modification to a configuration of a control point or a monitoring point, it is necessary to repeat the modification operation a number of times equal to the number of applicable equipment (which, in an office building, is the number of floors), and thus there has been a problem in that the operating efficiency has been poor.

In the monitoring device disclosed in Japanese Unexamined Patent Application Publication 2005-18119, even though efficiency was achieved at the time of initially defining the monitoring points and control points, there is no handling of operations for adding or changing monitoring points and control points, so this was enabled no improvement to the operating efficiency when making additions or changes.

### SUMMARY

The present invention was produced in order to solve the problem set forth above, and an aspect thereof is to provide an engineering device and a point information generating method able to increase the operating efficiency when adding or changing a monitoring point or control point.

The engineering device according to the present invention has a template producing unit that produces a template that defines monitoring point information and control point information as information for an object that is an equipment subject to monitoring/control, a system defining unit that defines system information for each equipment of a facility that is subject to monitoring/control, a physical entity deploying unit that produces monitoring point information and control point information for each individual equipment by deploying the template, for each individual equipment within the facility, following the system information, and a modification processing unit that regenerates the monitoring point information and control point information for each individual equipment, by deploying, to each individual equipment within the facility, a post-modification template, following the system information, when a modification has been made to the template.

Additionally, the point information generating method according to the present invention includes a template producing step for producing a template that defines monitoring point information and control point information as information for an object that is an equipment subject to monitoring/control, a system defining step for defining system information for each equipment of a facility that is subject to monitoring/control, a physical entity deploying step for producing monitoring point information and control point information for each individual equipment by deploying the template, for each individual equipment within the facility, following the system information, and a modification processing step for regenerating the monitoring point information and control point information for each individual equipment, by deploying, to each individual equipment within the facility, a post-modification template, following the system information, when a modification has been made to the template.

Given the present invention, it is possible to greatly increase the operational efficiency, when compared to that which is conventional, because it is possible to reflect the details of modifications through deploying, to each individual equipment of a facility that is subject to monitoring/control, a post-modification template in accordance with a modification in a template when there has been a modification to the configuration of a monitoring point/control point.

### BRIEF DESCRIPTIONS OF THE DRAWINGS

FIG. 1 is a block diagram illustrating the structure of an engineering device according to an example according to the present invention.

FIG. 2 is a flowchart illustrating the operation when producing information in an engineering device according to an example according to the present invention.

FIG. 3 is a diagram illustrating one example of an air-conditioning device and a controller.

FIG. 4 is a diagram illustrating one example of control point information, a control evaluation flag, and a calendar date report applicability flag.

FIG. 5 is a diagram illustrating one example of a summary graph.

FIG. 6 is a cross-sectional diagram illustrating an equipment layout in an office building.

FIG. 7A through 7B are plan view diagrams illustrating equipment layouts in an office building.

FIG. 8 is a diagram illustrating an example of grouping of objects by tenant units.

FIG. 9 is a flowchart illustrating operations when a point has been modified in an engineering device according to an example according to the present invention.

### DETAILED DESCRIPTION

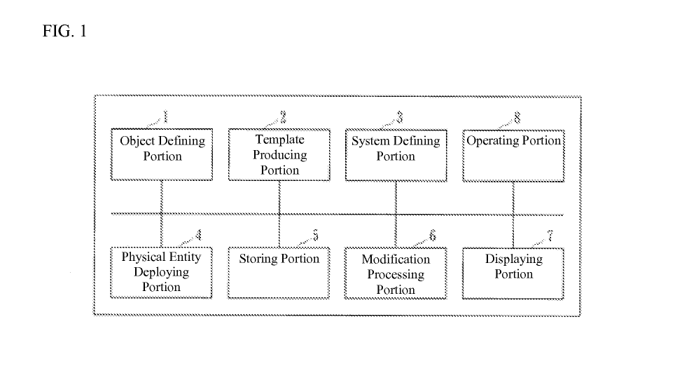

An example according to the present invention will be explained below referencing the drawings. FIG. 1 is a block diagram illustrating the structure of an engineering device according to an example according to the present invention. The engineering device is equipped with an object defining portion 1, a template producing portion 2, a system defining portion 3, a physical entity deploying portion 4, a storing portion 5, a modification processing portion 6, a displaying portion 7, and an operating portion 8.

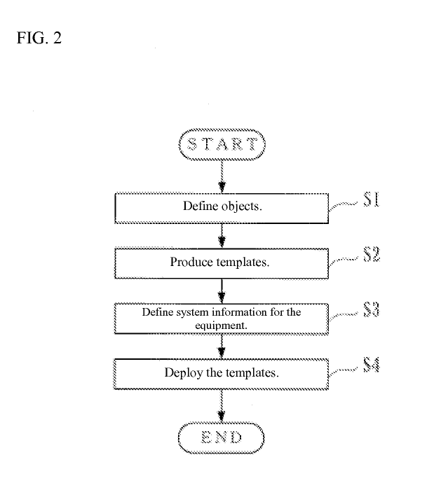

FIG. 2 is a flowchart illustrating the operations in the engineering device. The object defining portion 1 defines, as an object, an object such as an equipment, a device, an instrument, or the like, that is subject to monitoring/control (Step S1 in FIG. 2). As specific examples of objects there are, for example, air-conditioning equipment, lighting equipment, and anti-theft equipment.

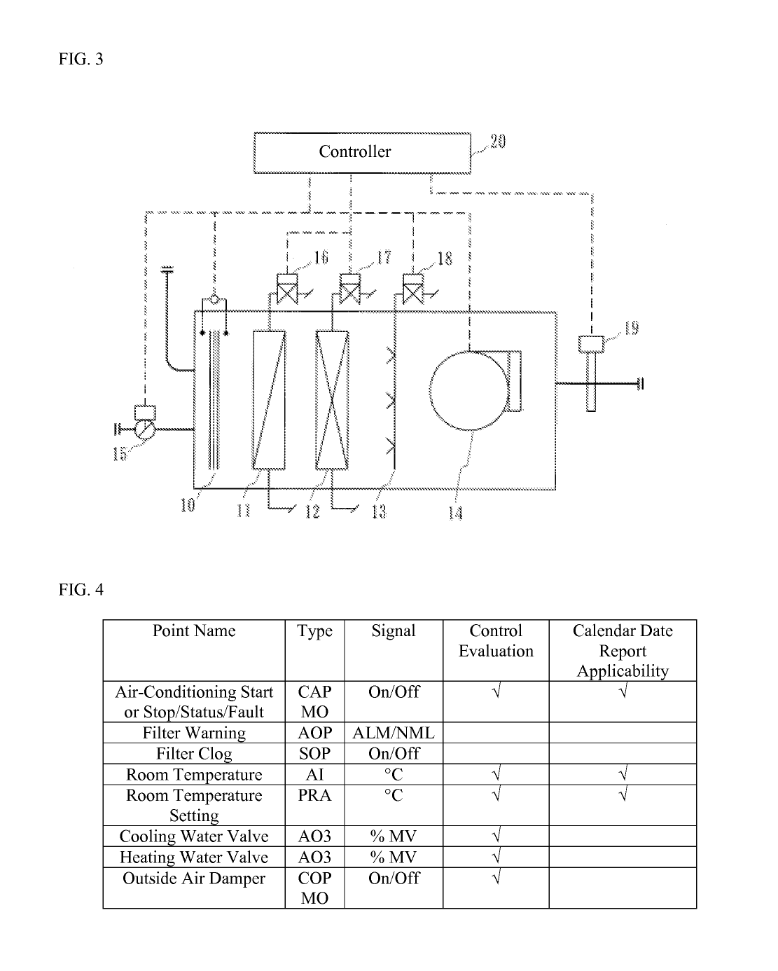

FIG. 3 is a diagram illustrating one example of an air-conditioning device and a controller for controlling the air-conditioning device. The air-conditioning device has a filter 10, a cold water coil 11 for cooling the air, a hot water coil 12 for heating the air, a humidifier 13, a fan for blowing the air that has been cooled or heated, an outside air damper 15 for controlling the amount of outside air that is drawn in, a cold water valve 16 for controlling the amount of cold water that is fed to the cold water coil 11, a hot water valve 17 for controlling the amount of hot water that is fed to the hot water coil 12, a humidifier valve 18 for controlling the amount of cold water or hot water sent to the humidifier 13, a supply air temperature sensor 19 for measuring the temperature of the air (supply air) that is sent to the air-conditioning equipment, and the like.

The controller 20 acquires state information from the filter 10, acquires flow rate or RPM information from the fan 14, acquires opening information from the outside air damper 15, the cold water valve 16, the hot water valve 17, and the humidifier valve 18, and acquires supply air temperature information from the supply air temperature sensor 19. Given this, the controller 20 controls the fan 14, the outside air damper 15, the cold water valve 16, the hot water valve 17, and the humidifier valve 18, so as to cause the room temperature and humidity to go to preferred values. The object defining portion 1 defines, as objects, objects such as equipment, devices, instruments, and the like, in accordance with inputs from a user who operates the operating portion 8.

Following this, the template producing portion 2 creates a template for the object and the controller by defining, as object information, monitoring (input/output) point information, information for control points required in control calculations, summary graph information for displaying the state of the monitoring point/control point, control evaluation flags set for each individual point, calendar date report applicability flags set for each individual point, and the like, and also defining controller information (Step S2 in FIG. 2). The control evaluation flags are flags indicating whether or not to collect data for control evaluation and whether or not to collect data for producing trend graphs. The calendar date report applicability flags are flags indicating whether or not to collect data for producing calendar date reports. Through producing control evaluation flags and calendar date report applicability flags for each point in this way it is possible to perform, in a centralized manner, operations that conventionally have been recorded one point at a time. As described below, when there is a modification in a template this makes it possible to perform an operation for deployment centrally as if it were a single point.

FIG. 4 is a diagram illustrating one example of control point information, a control evaluation flag, and a calendar date report applicability flag, corresponding to the air-conditioning device illustrated in FIG. 3. The control point information includes a point name that is an identifier required for specifying the control point, a point type, and information such as a code (an engineering unit) for the data obtained from the monitoring point. Moreover, as illustrated in FIG. 4, the control evaluation flag and the calendar date report applicability flag are flags that are set for those points for which data are to be collected. In the example in FIG. 4, flags that are set are indicated by checkmark symbols

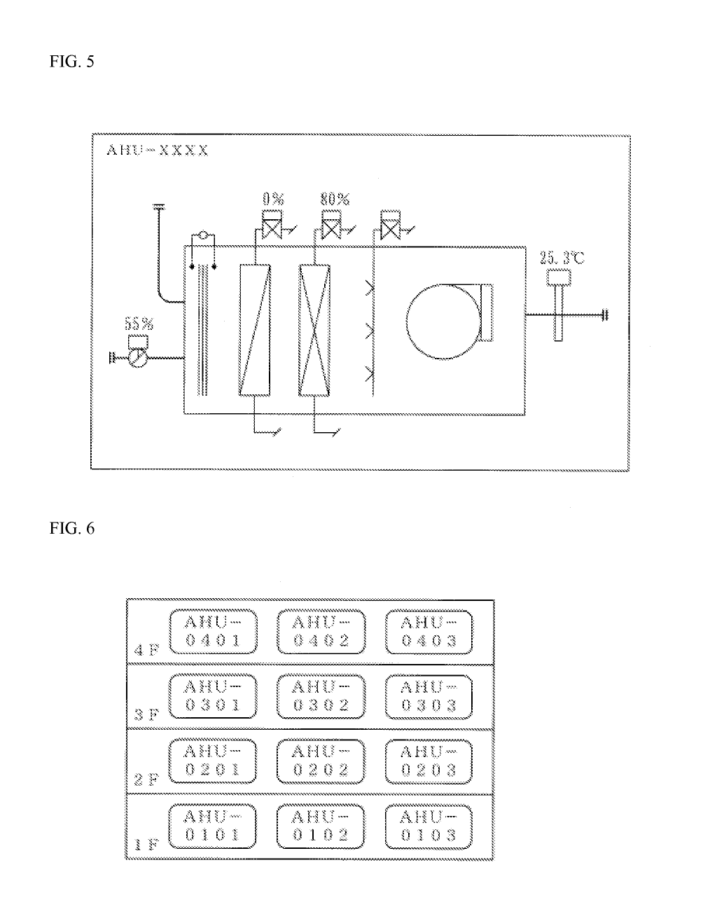

FIG. 5 is a diagram illustrating one example of a summary graph corresponding to the air-conditioning device illustrated in FIG. 3. The summary graph displays the state of the monitoring point and control point in real time, using a plan view diagram or a cross-sectional diagram. The information for displaying a summary graph on the screen of a monitoring device is the summary graph information. The template producing portion 2 produces a template that defines object information and controller information for in accordance with an input from a user who operates the operating portion 8. The template that is produced by the template producing portion 2 is stored in the storing portion 5.

Following this, the system defining portion 3 defines system information for the equipment, in order to apply the templates to physical entities (Step S3 in FIG. 2). The system information includes name information for the equipment and location information for the equipment.

In order to explain the system information, one example of an office building wherein the first floor is a lobby and conference rooms, and the second floor through the fourth floor are offices, will be used as one example of a facility that is subject to monitoring/control. Here equipment known as “AHU-0102” is installed as air-conditioning equipment in the lobby on the first floor. Moreover, an equipment known as “AHU-0101” is installed as air-conditioning equipment for the elevator hall (hereinafter termed the “EV hall”) and hallway on the first floor, equipment known as “AHU-0201” is installed as air-conditioning equipment for the EV hall and hallway on the second floor, equipment known as “AHU-0301” is installed as air-conditioning equipment for the EV hall and hallway on the third floor, and equipment known as “AHU-0401” is installed as air-conditioning equipment for the EV hall and hallway on the fourth floor.

Furthermore, equipment known as “AHU-0103” is installed as air-conditioning equipment for a first floor conference room, and equipment known as “AHU-0202” and “AHU-0203” are installed as air-conditioning equipment for the second-floor offices, equipment known as “AHU-0302” and “AHU-0303” are installed as air-conditioning equipment for the third-floor offices, and equipment known as “AHU-0402” and “AHU-0403” are installed as air-conditioning equipment for the fourth-floor offices.

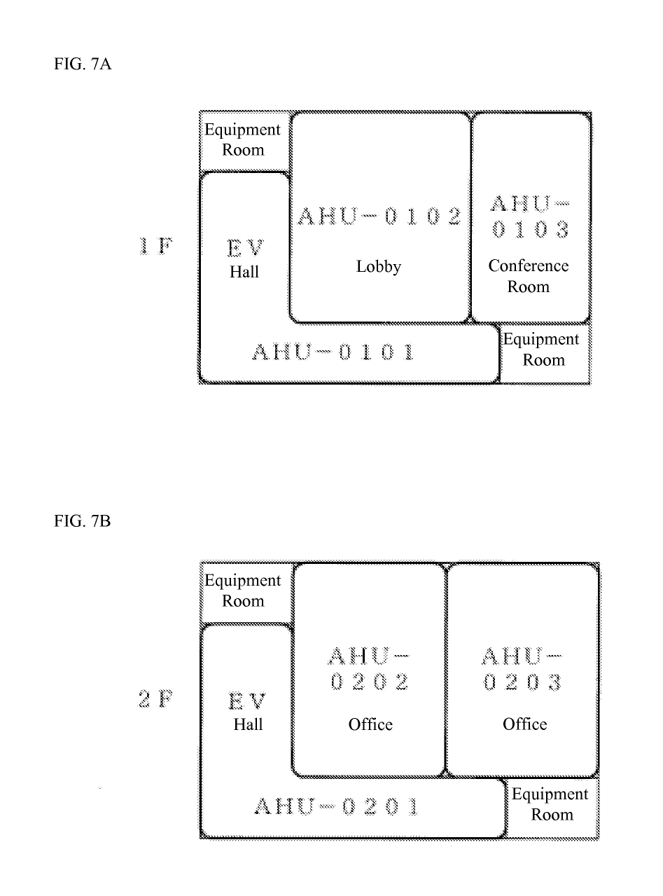

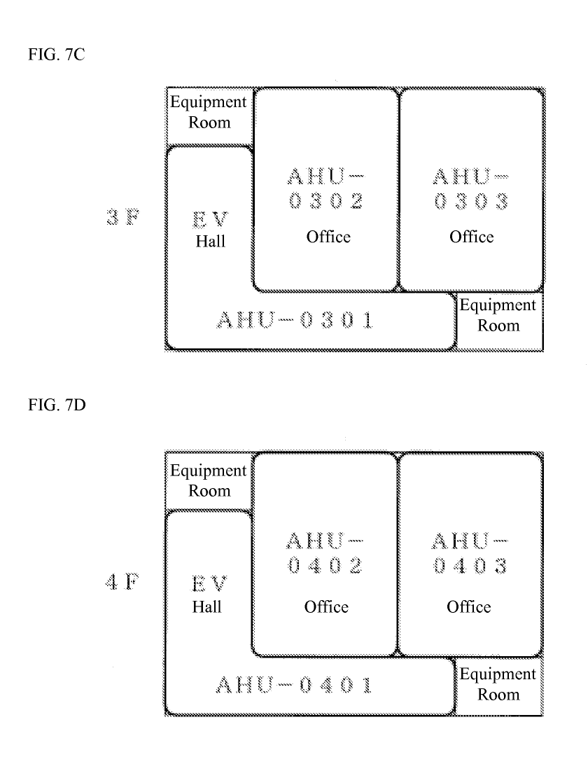

The office building equipment layout, as described above, is as in FIG. 6 when shown in a cross-section, and as in FIG. 7A, FIG. 7B, FIG. 7C, and FIG. 7D, when shown in the plan view. FIG. 7A, FIG. 7B, FIG. 7C, and FIG. 7D are plan views of, respectively, the first floor, the second floor, the third floor, and the fourth floor. For example, for the first floor EV hall and hallway, “AHU-0101” is the name information for the equipment, and “1F EV hall, hallway” is the location information for the equipment. By including the floor information, such as, for example “1F” in the location information is possible to group these objects, after application to the physical entities, by floor. Because the building architecture stacks up floors starting at the bottom, often the building construction/adjustment operations are performed by the floor unit. In the present example, after application to the physical entities, the objects are grouped by floors, making it possible, for example, to produce requirements simultaneously for each equipment on a single floor from a monitoring device.

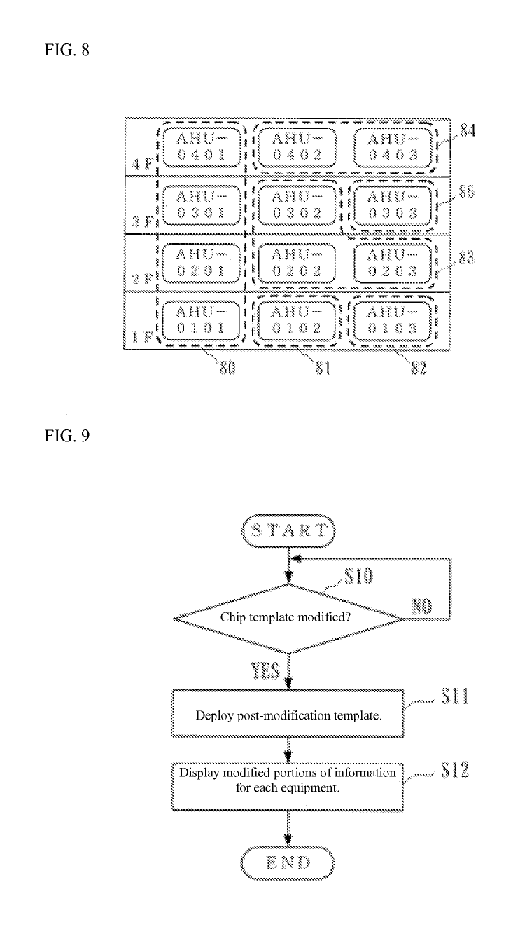

Moreover, when it is necessary to perform mapping of equipment on a plan view diagram, the location information should be defined by locations on the plan view diagram, such as illustrated in FIG. 7A through FIG. 7D. Moreover, the system information may also include information for tenants (users). An example wherein objects are grouped by tenant units is shown in FIG. 8. In the example in FIG. 8, the air-conditioning equipment “AHU-0101,” “AHU-0201,” “AHU-0301,” and “AHU-0401” are grouped together in group 80 for the EV halls and hallways, where the air-conditioning equipment “AHU-0102” is grouped into group 81 for the lobby, and air-conditioning equipment “AHU-0103” is grouped into group 82, for the conference room. Moreover, the air-conditioning equipment “AHU-0202,” “AHU-0203,” and “AHU-0302,” are grouped into a group 83 for a tenant by the name of “AA Enterprises,” air-conditioning equipment “AHU-0402,” and “AHU-0403” are grouped into a group 84 for a tenant by the name of “BA Construction,” and the air-conditioning equipment “AHU-0303” is grouped into a group 85 for vacant tenants.

In a leased building, objects in the operating stage, after application to the physical entities, grouping by the tenant physical entity makes it possible to perform operations, such as setting time schedules, setting temperature settings, and the like, through centralized operations, where in the past this has been through operations where individual points were registered or selected, thus enabling increased efficiency in operating by tenant units. When there is a modification in tenant relationships, this can be performed through an operation that is deployed centrally, in the same manner as with points. The system defining portion 3 defines system information for the equipment in accordance with inputs from a user that operates the operating portion 8. The system information is stored in the storing portion 5.

Following this, the physical entity deploying portion 4 follows the system information that is stored in the storing portion 5 to deploy the templates for the various equipment of the facilities that are to be subject to monitoring and control, to apply the objects to physical entities (Step S4 in FIG. 2). The template deployment generates the monitoring point information, the control point information, the summary graph information, the control evaluation flags, and the calendar date report applicability flags for each of the equipment of the facility that is subject to monitoring and control. For example, the monitoring point information, control point information, summary graph information, control evaluation flag, and calendar date report flag are generated for the equipment by the name of “AHU-0101” for the EV hall and hallway on the first floor. The physical entity deploying portion 4 stores the generated information into the storing portion 5.

The operations when generating information in the engineering device are completed through the above. The monitoring operations, not shown, collect data from the monitoring points of the various equipment in the facility that is subject to monitoring and control, based on the monitoring information produced by the engineering device, and controls the various equipment in the facility that is subject to monitoring/control based on the control point information produced by the engineering device, and a summary graph of the facility that is subject to monitoring/control is displayed based on the summary graph information produced by the engineering device.

Following this, the operation of the engineering device in the case of a modification to the configuration of a monitoring point or control point will be explained using the flowchart of FIG. 9. When there is a modification to the configuration of a monitoring point or a control point, the user operates the operating portion of the engineering device, to modify the monitoring point or control point information of the template. After this, the user issues an instruction to the engineering device to deploy the details of the modification to the physical entities.

The modification processing portion 6, upon receipt of the instruction from the user, identifies that a template has been modified (YES in Step S10 in FIG. 9), and follows the system information that is stored in the storing portion 5 to deploy the post-modification template to the various equipment of the facility that is subject to monitoring/control, to regenerate the monitoring point information, control point information, summary graph information, control evaluation flag, and calendar date report applicability flag for each individual equipment (Step S11 in FIG. 9). The information that that was produced and stored into the storing portion 5 by the physical entity deploying portion 4 in Step S4 is overwritten with the information that is generated by the modification processing portion 6. The operation for modifying the monitoring points and control points is completed in this way. The control evaluation flags and calendar date report applicability flags for the individual points can be modified in the same way.

With the conventional engineering tools it was necessary to repeat the modification operations for each of the plurality of equipment when there was a modification in the configuration of a monitoring point or a control point. In contrast, when, in the present example, there is a modification to the configuration of a monitoring point or a control point, a post-modification template is deployed to all of the equipment in the facility that is subject to monitoring/control, in accordance with the modification in the template, reflecting the details of the modification, thereby making it possible to increase greatly the operating efficiency relative to the past.

Note that it is also possible to correct information for equipment after deployment when the actual equipment has a part that is different from the template in only one place. When there is a modification to the actual equipment, a modification flag, indicating that the equipment has been modified, can be stored by a user operation in the storing portion 5. If the modification flag is set when the modification processing portion 6 deploys the post-modification template to each individual equipment within the facility that is subject to monitoring/control, in Step S11, the user may select to either modify or not modify the information according to the template for the equipment for which the modification flag has been set. This makes it possible to for the user to select whether or not to overwrite the monitoring point information and control point information for the actual equipment. A message to prompt the selection is displayed on the displaying portion 7.

When a user sees the message and operates the operating portion 8 to select to modify the information according to the template, then the modification processing portion 6 performs the processes of Step S11. On the other hand, when the user selects to not modify the information, then the modification processing portion 6 executes the processes of Step S11 for the equipment for which the modification flag is not set, and does not execute the processes of Step S11 for the equipment for which the modification flag is set. The user corrects manually the monitoring point information, the control point information, the summary graph information, the control evaluation flag, and the calendar date report applicability flag for the equipment for which the modification flag has been set.

Moreover, because the modification operations in Step S11 in the engineering device are automatic, the user is unable to verify the modification operations visually. Given this, in order to respond to the desires of the users, the displaying portion 7 may display a list of the modified portions of the information for each individual equipment (Step S12 in FIG. 9). Doing so enables the user to check the template deployment operations. Moreover, the displaying portion 7 may also display the deployment of the modified portions in the template to the actual equipment.

The engineering device according to the present example may be embodied as a computer equipped with a CPU, a storage device, and an external interface, and a program for controlling these hardware resources. The CPU executes the processes explained in the present example, following a program that is stored in the storage device.

The present invention can be applied to technologies for producing monitoring point information and control point information for use in monitoring devices for monitoring and controlling facilities such as office buildings.

1. An engineering device comprising:
a template producing unit that produces a template that defines monitoring point information and control point information as information for an object that is an equipment subject to monitoring/control;
a system defining unit that defines system information for each equipment of a facility that is subject to monitoring/control;
a physical entity deploying unit that produces monitoring point information and control point information for each individual equipment by deploying the template, for each individual equipment within the facility, following the system information; and
a modification processing unit that regenerates the monitoring point information and control point information for each individual equipment, by deploying, to each individual equipment within the facility, a post-modification template, following the system information, when a modification has been made to the template.

2. The engineering device as set forth in claim 1, wherein:
the modification processing unit, when, among the various equipment, there is equipment that has been modified, causes a user to select whether to modify or not modify information according to the post-modification template for the modified equipment when deploying the post-modification template to each equipment within the facility.

3. The engineering device as set forth in claim 1, further comprising:
a displaying unit that displays a modified portion of information for each individual equipment when a post-modification template has been deployed for each individual equipment of the facility.

4. A point information generating method comprising:
a template producing step for producing a template that defines monitoring point information and control point information as information for an object that is an equipment subject to monitoring/control;
a system defining step for defining system information for each equipment of a facility that is subject to monitoring/control;
a physical entity deploying step for producing monitoring point information and control point information for each individual equipment by deploying the template, for each individual equipment within the facility, following the system information; and
a modification processing step for regenerating the monitoring point information and control point information for each individual equipment, by deploying, to each individual equipment within the facility, a post-modification template, following the system information, when a modification has been made to the template.

5. The point information generating method as set forth in claim 4, wherein:
the modification processing step is a step wherein, when, among the various equipment, there is equipment that has been modified, a user is caused to select whether to modify or not modify information according to the post-modification template for the modified equipment when deploying the post-modification template to each equipment within the facility.

6. The point information generating method as set forth in claim 4, further including:
a displaying step for displaying a modified portion of information for each individual equipment when a post-modification template has been deployed for each individual equipment of the facility.
